(19) United States
(12) Patent Application Publication
(10) Pub. No.: US 2018/0270914 A1
(43) Pub. Date: Sep. 20, 2018

(54) POWER DELIVERY SYSTEM FOR AN INDUCTION COOKTOP WITH MULTI-OUTPUT INVERTERS

(71) Applicant: WHIRLPOOL CORPORATION, BENTON HARBOR, MI (US)

(72) Inventors: Carlo Calesella, Castelmassa (IT); Davide Parachini, Cassano Magnago (IT); Cristiano Vito Pastore, Comerio (IT)

(73) Assignee: WHIRLPOOL CORPORATION, BENTON HARBOR, MI (US)

(21) Appl. No.: 15/460,705

(22) Filed: Mar. 16, 2017

(51) Int. Cl. H05B 6/06

(52) U.S. Cl. CPC H05B 6/065

(57) ABSTRACT

A power delivery system and method for an induction cooktop are provided herein. A plurality of inverters are each configured to apply an output power to a plurality of induction coils electrically coupled thereto via corresponding relays. A selected inverter is operable to momentarily idle to enable commutation of a relay connected thereto. An active inverter is operable to increase its output power for the duration in which the selected inverter is idled in order to lessen power fluctuations experienced on a mains line.

### FIELD OF THE INVENTION

The present invention generally relates to induction cooktops, and more particularly, to a power delivery system for an induction cooktop having high frequency inverters applying output power to multiple induction coils.

### BACKGROUND OF THE INVENTION

Induction cooktops typically employ high frequency inverters to apply power to induction coils in order to heat a load. In induction cooktops having inverters that each apply power to multiple induction coils, a common drawback is the fluctuation of power experienced on a mains line during power balancing of the induction coils. Accordingly, there is a need for a power delivery system that lessens power fluctuations experienced on the mains line.

### SUMMARY OF THE INVENTION

According to one aspect of the present invention, a power delivery system for an induction cooktop is provided herein. A plurality of inverters are each configured to apply an output power to a plurality of induction coils electrically coupled thereto via corresponding relays. A selected inverter is operable to momentarily idle to enable commutation of a relay connected thereto. An active inverter is operable to increase its output power for the duration in which the selected inverter is idled in order to lessen power fluctuations experienced on a mains line.

According to another aspect of the present invention, an induction cooktop is provided including a plurality of induction coils. A plurality of relays are each connected to a corresponding induction coil. A plurality of inverters are each connected to more than one relay and are each configured to apply an output power to the corresponding induction coils. At least one selected inverter is operable to momentarily idle to enable commutation of a relay connected thereto. At least one active inverter is operable to increase its output power for the duration in which the at least one selected inverter is idled in order to lessen power fluctuations experienced on a mains line.

According to yet another aspect of the present invention, a power delivery method for an induction cooktop is provided. The method includes the steps of: providing a plurality of inverters, each of which is configured to apply an output power to a plurality of induction coils electrically coupled thereto via corresponding relays; momentarily idling a selected inverter to enable commutation of a relay connected thereto; and increasing an output power of an active inverter for the duration in which the selected inverter is idled in order to lessen power fluctuations experienced on a mains line.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a circuit diagram of a power delivery system for an induction cooktop, the power delivery system having high frequency inverters configured to apply output power to multiple induction coils;

FIG. 2 is an exemplary pulse width modulation scheme illustrating the output power of the inverters over a control period and the resulting power fluctuations on a mains line caused by an uncompensated power drop experienced during the idling of a selected inverter in order to commutate a relay connected thereto;

FIG. 3 again illustrates the output power of the inverters over the control period, wherein the inverters are configured to fully compensate the power drop in order to lessen power fluctuations on the mains line; and

FIG. 4 yet again illustrates the output power of the inverters over the control period, wherein the inverters are configured to partially compensate the power drop in order to lessen power fluctuations on the mains line;

### DETAILED DESCRIPTION OF THE PREFERRED EMBODIMENTS

As required, detailed embodiments of the present invention are disclosed herein.

However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

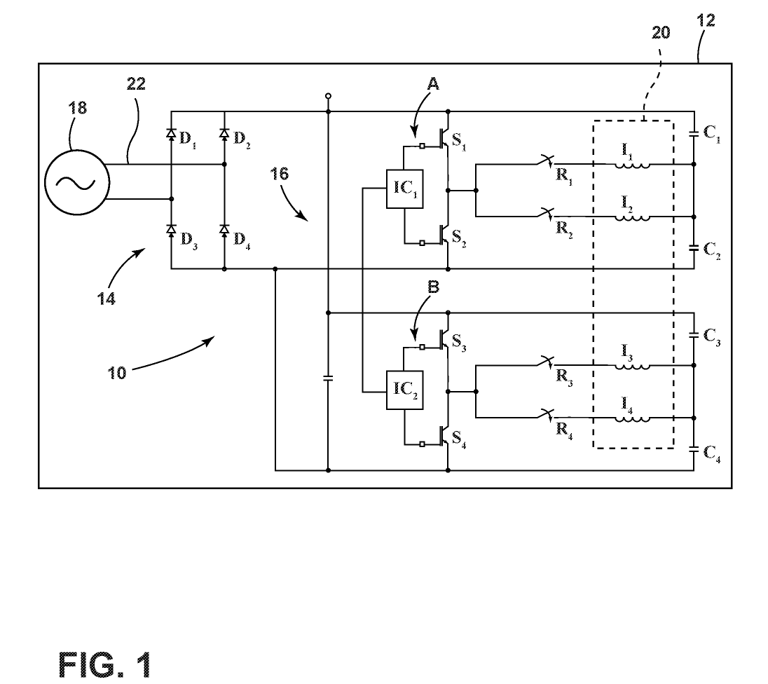

Referring to FIG. 1, a power delivery system 10 is shown for an induction cooktop generally designated by reference numeral 12. The power delivery system 10 may include a rectifier 14, a DC bus 16, and a plurality of high frequency inverters exemplarily shown as inverters A and B. In the depicted embodiment, the rectifier 14 is electrically coupled to AC mains 18 and is configured to convert AC voltage into DC voltage. The rectifier 14 may include diodes D₁-D₄ arranged in a conventional full-wave diode bridge configuration. Alternatively, the rectifier 14 may include a bridge configuration having silicon-controlled rectifiers (SCRs) or insulated gate bipolar transistors (IGBTs). The DC bus 16 is electrically coupled to the rectifier 14 and is configured to stabilize and smooth rectifier output using one or more capacitors, inductors, or a combination thereof.

Inverters A and B are electrically coupled to the DC bus 16 and are configured to convert DC voltage back into AC voltage. Inverters A and B may each include a pair of electronic switches controlled by one or more microcontrollers using pulse width modulation (PWM) to perform the DC to AC conversion and generate inverter output. In the depicted embodiment, inverter A includes switches S₁and S₂ while inverter B includes switches S₃ and S₄. Switches S₁-S₄ may be configured as IGBTs or any other switch commonly employed in high frequency inverters. Although the inverters A, B are shown as having a series resonant half-bridge topology, it is to be understood that other inverter topologies may be otherwise adopted such as, but not limited to, full bridge, single-switch quasi-resonant, or active-clamped quasiresonant.

Switches S₁ and S₂ may be controlled by microcontroller IC₁ and switches S₃ and S₄ may be controlled by microcontroller IC₂. Microcontrollers IC₁ and IC₂ may be in electrical communication to operate the switches S₁-S₄ accordingly during a PWM control scheme. Alternatively, a single microcontroller IC may be provided to control switches S₁-S₄. For the sake of clarity and simplicity, only two inverters A, B are shown in FIG. 1. However, it will be understood that additional inverters may be similarly provided in alternative embodiments.

With continued reference to FIG. 1, a plurality of induction coils I₁-I₄ are provided and are operable to heat one or more loads placed on a heating area 20 of the induction cooktop 12. In the depicted embodiment, induction coils I₁ and I₂ are each electrically coupled to the output of inverter A via a series connection with a corresponding electromechanical relay R₁, R₂. Relays R₁ and R₂ are operable between an opened and a closed position to determine an activation state of the corresponding induction coil I₁, I₂. Induction coils I₁ and I₂ are also electrically coupled to capacitors C₁ and C₂ to establish a resonant load for the electronic switches S₁, S₂ of inverter A. Similarly, induction coils 1₃ and 1₄ are each electrically coupled to the output of inverter B via a series connection with a corresponding electromechanical relay R₃, R₄, each operable between an opened and a closed position to determine an activation state of the corresponding induction coil I₃, I₄. Induction coils 1₃ and 1₄ are also electrically coupled to capacitors C₃ and C₄ to establish a resonant load for the electronic switches S₃, S₄ of inverter B. While capacitors C₁ and C₂ are depicted as being shared between induction coils I₁ and I₂, it will be appreciated that separate capacitors may be uniquely assigned to each of the induction coils I₁, I₂ in alternative embodiments. The same is true with respect to the arrangement between induction I₃ and I₄ and capacitors C₃ and C₄.

Generally speaking, electromechanical relays are preferable over solid state solutions due to favorable characteristics such as lower heat dissipation, lower cost, and lower physical volume. In order to operate reliably, electromechanical relays are typically commutated at zero current. Otherwise, the service life of the electromechanical relays may be inadequate for use in household applications. With respect to the depicted embodiment, commutation at zero current is achieved by opening or closing a selected relay(s) R₁-R₄ during a momentary idling of the corresponding inverter A, B. This idling process is referred to herein as “idle-before-make.” During the idle-before-make process, the corresponding inverter A, B is typically deactivated for some tens of milliseconds, which may lead to large power fluctuations on a mains line 22. Since larger power fluctuations typically require longer control periods in order to comply with regulatory standards (e.g., standard IEC 61000-3-2), one concern is that when the inverters A, B are operated near full power (e.g., 3600 W for a 16A phase), an idle-before-make process may provoke a power fluctuation requiring a corresponding control period to be in the order of minutes, which is undesirable from a power uniformity standpoint. Furthermore, large power fluctuations may induce flicker on the mains line 22.

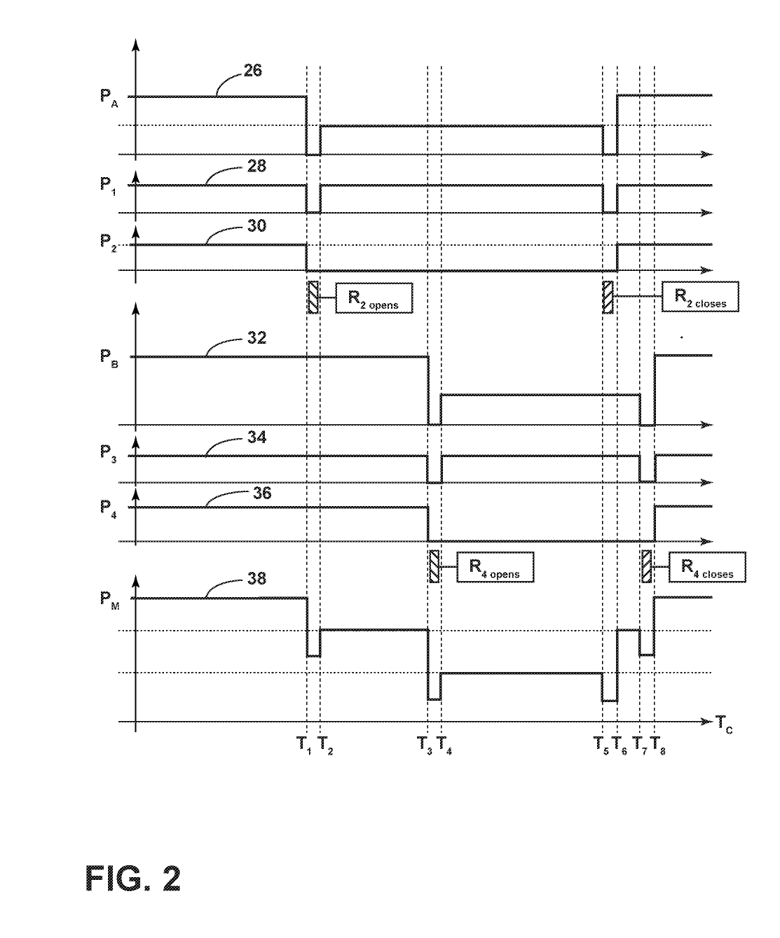

To better understand the foregoing principles, reference is made to FIG. 2, which illustrates an exemplary PWM control scheme 24 using inverters A and B under the control of microcontrollers IC₁ and IC₂. In the depicted embodiment, line 26 represents an output power P_{A} of inverter A applied to induction coils I₁ and/or I₂ over the course of a control period T_{c} that includes times T₁-T₈. With respect to the embodiments described herein, it is understood that the control period T_{c} may end at time T₈ or otherwise continue beyond time T₈.

For reference, line 28 represents an output power P₁ of inverter A applied exclusively to induction coil I₁ over the course of the control period T_{c}, and line 30 represents an output power P₂ of inverter A applied exclusively to induction coil I₂ over the course of the control period T_{c}. Since inverter A supplies power to both induction coils I₁ and 1₂, it will be understood that the output power P_{A} of inverter A corresponds to a sum of the instantaneous output powers P₁, P₂ applied to induction coils I₁ and I₂.

Likewise, line 32 represents an output power P_{B} of inverter B applied to induction coils I₃ and/or I₄ over the course of the control period T_{c}. For reference, line 34 represents an output power P₃ of inverter B applied exclusively to induction coil I₃ over the course of the control period T_{c}, and line 36 represents an output power P₄ of inverter B applied exclusively to induction coil I₄ over the course of the control period T_{c}. Since inverter B supplies power to both induction coils I₃ and I₄, it will be understood that the output power P_{B} of inverter B corresponds to the instantaneous output powers P₃, P₄ applied to induction coils I₃ and I₄.

Lastly, line 38 represents the fluctuation of power Pₘ on the mains line 22 over the course of the control period T_{c}. Since the mains line 22 is responsible for supplying power to inverters A and B, it follows that the fluctuation experienced by the mains line 22 is the sum of the instantaneous output powers P_{A}, P_{B} of inverters A and B, or equivalently, the sum of the instantaneous output powers P₁-P₄ applied to induction coils I₁-I₄. As a consequence, if one or more of the relays R₁-R₄ are commutated for the purposes of adjusting power between the induction coils I₁-I₄, a power fluctuation will be experienced by the mains line 22 as a result of the corresponding inverter A, B being momentarily idled.

For example, inverter A is momentarily idled between times T₁ and T₂ and again between times T₅ and T₆ in order to commutate relay R₂ at zero current. Specifically, relay R₂ is opened while inverter A is momentarily idled between times T₁ and T₂ in order to deactivate induction coil I₂, and closed while inverter A is momentarily idled between times T₅ and T₆ in order to reactivate induction coil I₂. During each momentary idling of inverter A, output powers P₁ and P₂ cease to be applied to induction coils I₁ and I₂, respectively, and as a result, the instantaneous output power P_{A} of inverter A is zero between times T₁ and T₂, and times T₅ and T₆, thereby causing a corresponding power fluctuation to be experienced in the mains line 22 during those time intervals.

As a further example, inverter B is momentarily idled between times T₃ and T₄ and again between times T₇ and T₈ in order to commutate relay R₄ at zero current. Specifically, relay R₄ is opened while inverter B is momentarily idled between times T₃ and T₄ in order to deactivate induction coil I₄, and closed while inverter B is momentarily idled between times T₇ and T₈ in order to reactivate induction coil I₄. During each momentary idling of inverter B, output powers P₃ and P₄ cease to be applied to induction coils I₃ and I₄, respectively, and as a result, the instantaneous output power P_{B} of inverter B is zero between times T₃ and T₄, and times T₇ and T₈, thereby causing a corresponding power fluctuation to be experienced in the mains line 22 during those time intervals.

In view of the above, a solution is provided herein to mitigate power fluctuation on the mains line 22. Specifically, in instances where a selected inverter(s) is momentarily idled in order to commutate a relay connected thereto at zero current, it is contemplated that at least one active inverter is operable to increase output power for the duration in which the selected inverter(s) is idled. The increased output power of the active inverter is applied to active induction coils associated therewith. During the idling of the selected inverter, the output power of an active inverter(s) is increased by an additional output power that may be predetermined or based on a pre-idle output power of the selected inverter(s). The additional output power may be equal to or less than a pre-idle output power of the selected inverter(s) that is applied to an associated induction coil(s) that was active before and remains active after the idling of the selected inverter(s), or in other words, maintains an electrical connection with the selected inverter(s) due to its corresponding relay remaining closed throughout the idling of the selected inverter(s). By increasing the output power of active inverters during an idle-before-make process, the resultant drop off in output power of an idled inverter is compensated, thereby lessening the corresponding power fluctuation experienced on the mains line 22.

For purposes of understanding, the PWM control scheme 24 is again illustrated in FIGS.

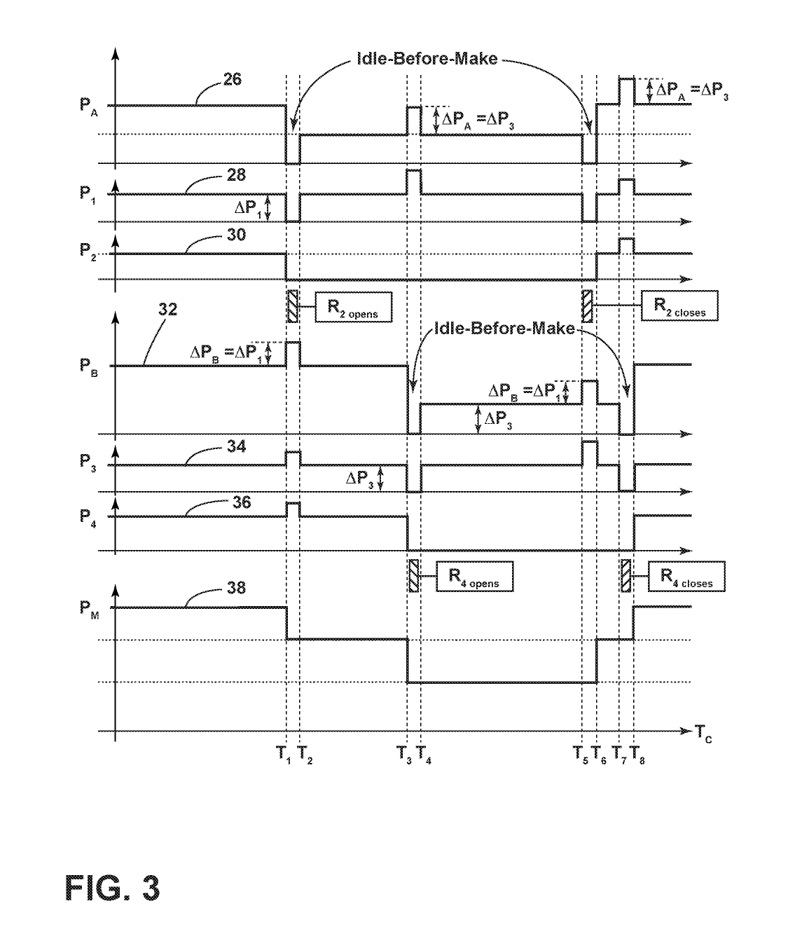

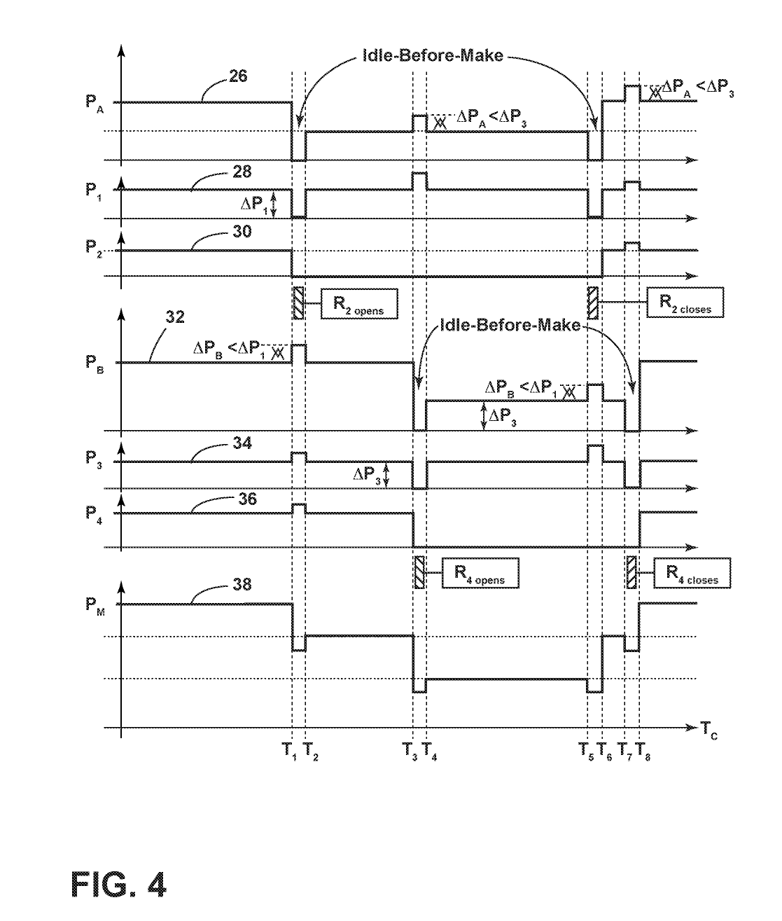

3 and 4, only this time, inverter B is operable to compensate for power fluctuation on the mains line 22 by increasing output power P₈ for the duration in which inverter A is momentarily idled between times T₁ and T₂, and between times T₅ and T₆, during which relay R₂ is commutated at zero current. Specifically, the output power P_{B} is increased by an additional output power ΔP_{B} that is equal to (FIG. 3) or less than (FIG. 4) a pre-idle output power ΔP₁ of inverter A that is applied to induction coil I₁. In embodiments where an additional induction coil(s) is connected to inverter A and maintains an electrical connection therewith throughout the idle-before-make process, the additional output power ΔP_{B} may be equal to or less than the sum of the pre-idle output power ΔP₁ applied to induction coil I₁ and the pre-idle output power applied to the additional induction coil(s). As shown in FIGS. 3 and 4, the increased output power (P_{B} +ΔP_{B}) is applied to active induction coils I₃ and I₄ between times T₁ and T₂, and is applied exclusively to induction coil I₃ between times T₅ to T₆ due to induction coil I₄ being inactive between times T₅ to T₆.

Likewise, inverter A is operable to compensate for power fluctuation on the mains line 22 by increasing output power P_{A} for the duration in which inverter B is momentarily idled between times T₃ and T₄, and between times T₇ and T₈, during which relay R₄ is commutated at zero current. Specifically, the output power PA is increased by an additional output power ΔP_{A} that is equal to (FIG. 3) or less than (FIG. 4) a pre-idle output power ΔP₃ of inverter B that is applied to induction coil I₃. In embodiments where an additional induction coil(s) is connected to inverter B and maintains an electrical connection therewith throughout the idle-before-make process, the additional output power ΔP_{A} may be equal to or less than the sum of the pre-idle output power ΔP₃ applied to induction coil I₃ and the pre-idle output power applied to the additional induction coil(s). As shown in FIGS. 3 and 4, the increased output power (P_{A}+ΔP_{A}) is applied exclusively to induction coil I₁ between times T₃ and T₄ due to induction coil I₂ being inactive between times T₃ and T₄, and is applied to induction coils I₁ and I₂ between times T₇ and T₈.

When FIGS. 3 and 4 are compared to FIG. 2, in which inverters A and B provide no compensation, the corresponding power fluctuation experienced by the mains line 22 between times T₁ and T₂, T₃ and T₄, T₅ and T₆, and T₇ and T₈ is lessened, especially when inverters A and B are configured in the manner described with reference to FIG. 3. While less compensation is achieved when inverters A and B are configured in the manner described with reference to FIG. 4, a power delivery system employing such inverters A, B is still preferable over one in which the inverters offer no compensation.

Regarding the embodiments shown in FIGS. 2-4, the duration in which inverters A and B are idled may be set equal to an integer number of mains half-cycles (e.g., 30 ms or 40 ms in a 50 Hz system) and may be synchronized with mains voltage zero crossings.

With respect to the embodiments shown in FIGS. 3 and 4, the output power P_{A}, P_{B} of inverters A and B may be reduced over the course of the control period T_{c} to offset the additional power ΔP_{A}, ΔP_{B} applied during idle-before-make processes. For example, inverters A and B both deliver an excess energy determined using the following equation:

E_{excess}=C·ΔAP·T (1)

In regards to equation 1, E_{xcess} denotes the excess energy delivered by a particular inverter, C is a variable denoting the number of times an additional power was applied by the inverter over the control period T_{c}, ΔP denotes the additional power applied by the inverter, and T denotes the duration in which the additional power was applied by the inverter and is typically equal to the duration of an idle-before-make process.

With respect to inverters A and B, equation 1 can be rewritten as follows:

E_{excess}=2·ΔP_{A}·T (2)

E_{excess}=2·ΔP_{B}·T (3)

Equation 2 allows for the excess energy of inverter A to be computed and equation 3 allows for the excess energy of inverter B to be computed. In both equations, variable C is equal to 2 due to inverters A and B twice applying their respective additional powers ΔP_{A}, ΔP_{B} over the course of the control period T_{c}.

Having determined the excess energy delivered by inverters A and B, the amount by which their output powers P_{A}, P_{B} are reduced over the course of the control period T_{c} is determined by taking the quotient between the corresponding excess energy and the control period T_{c}. It is contemplated that the reduction in output power P_{A}, P_{B} of inverters A and B may be implemented during one or more time intervals that are free of an idle-before-make process. For example, with respect to the embodiments shown in FIGS. 3 and 4, such time intervals include the start of the control period T_{c} to T₁, T₂ to T₃, T₄ to T₅, and T₆ to T₇.

Generally speaking, the duration T is relatively short compared to that of the control period T_{c}. Accordingly, the need to reduce output power for inverters applying one or more additional powers over the course of the control period T_{c} may be neglected without adversely impacting power balance between the inverters.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise. Further, the claims, as set forth below, are incorporated into and constitute part of this Detailed Description.

What is claimed is:

1. A power delivery system for an induction cooktop, comprising:
a plurality of inverters, each of which is configured to apply an output power to a plurality of induction coils electrically coupled thereto via corresponding relays;
wherein a selected inverter is operable to momentarily idle to enable commutation of a relay connected thereto; and
wherein an active inverter is operable to increase its output power for the duration in which the selected inverter is idled in order to lessen power fluctuations experienced on a mains line.

2. The power delivery system of claim 1, wherein the increased output power of the active inverter is applied to all active induction coils associated therewith.

3. The power delivery system of claim 1, wherein during the idling of the selected inverter, the output power of the active inverter is increased by an additional output power that is based on a pre-idle output power of the selected inverter.

4. The power delivery system of claim 3, wherein the additional output power is equal to the pre-idle output power of the selected inverter that is applied to at least one associated induction coil that was active before and remains active after the idling of the selected inverter.

5. The power delivery system of claim 3, wherein the additional output power is less than the pre-idle output power of the selected inverter that is applied to at least one associated induction coil that was active before and remains active after the idling of the selected inverter.

6. The power delivery system of claim 3, wherein the active inverter decreases its output power over the course of a control period to offset the additional power applied during the idling of the selected inverter.

7. The power delivery system of claim 1, wherein the duration in which the selected inverter is idled is set equal to an integer number of mains half-cycles and is synchronized with mains voltage zero crossings.

8. An induction cooktop comprising:
a plurality of induction coils;
a plurality of relays, each of which is connected to a corresponding induction coil;
a plurality of inverters, each of which is connected to more than one relay and configured to apply an output power to the corresponding induction coils;
wherein at least one selected inverter is operable to momentarily idle to enable commutation of a relay connected thereto; and
wherein at least one active inverter is operable to increase its output power for the duration in which the at least one selected inverter is idled in order to lessen power fluctuations experienced on a mains line.

9. The induction cooktop of claim 8, wherein the increased output power of the at least one active inverter is applied to all active induction coils associated therewith.

10. The induction cooktop of claim 8, wherein during the idling of the at least one selected inverter, the output power of the at least one active inverter is increased by an additional output power that is based on a pre-idle output power of the at least one selected inverter.

11. The induction cooktop of claim 10, wherein the additional output power is equal to the pre-idle output power of the at least one selected inverter that is applied to at least one associated induction coil that was active before and remains active after the idling of the at least one selected inverter.

12. The induction cooktop of claim 10, wherein the additional output power is less than the pre-idle output power of the at least one selected inverter that is applied to at least one associated induction coil that was active before and remains active after the idling of the at least one selected inverter.

13. The induction cooktop of claim 10, wherein the at least one active inverter decreases its output power over the course of a control period to offset the additional power applied during the idling of the at least one selected inverter.

14. The induction cooktop of claim 8, wherein the duration in which the at least one selected inverter is idled is set equal to an integer number of mains half-cycles and is synchronized with mains voltage zero crossings.

15. A power delivery method for an induction cooktop, comprising the steps of:
providing a plurality of inverters, each of which is configured to apply an output power to a plurality of induction coils electrically coupled thereto via corresponding relays;
momentarily idling a selected inverter to enable commutation of a relay connected thereto; and
increasing an output power of an active inverter for the duration in which the selected inverter is idled in order to lessen power fluctuations experienced on a mains line.

16. The power delivery method of claim 15, wherein the increased output power of the active inverter is applied to all active induction coils associated therewith.

17. The power delivery method of claim 15, wherein during the idling of the selected inverter, the output power of the active inverter is increased by an additional output power that is based on a pre-idle output power of the selected inverter.

18. The power delivery method of claim 17, wherein the additional output power is equal to or less than the pre-idle output power of the selected inverter that is applied to at least one associated induction coil that was active before and remains active after the idling of the selected inverter.

19. The power delivery method of claim 17, further comprising the step of decreasing the output power of the active inverter over the course of a control period to offset the additional power applied during the idling of the selected inverter.

20. The power delivery method of claim 15, wherein the duration in which the selected inverter is idled is set equal to an integer number of mains half-cycles and is synchronized with mains voltage zero crossings.
